(19) United States
(12) Patent Application Publication
(10) Pub. No.: US 2024/0154994 A1
(43) Pub. Date: May 9, 2024

(54) AUTOMATED SYSTEM ACCESS REVIEW USING INTER-SYSTEM MAPPINGS

(71) Applicant: VANTA INC., San Francisco, CA (US)

(72) Inventors: Toni Ng, Oakland, CA (US); Sijia Lu, San Francisco, CA (US); Cathy Liu, San Francisco, CA (US)

(21) Appl. No.: 18/498,775

(22) Filed: Oct. 31, 2023

Related U.S. Application Data
(60) Provisional application No. 63/382,831, filed on Nov. 8, 2022.

(51) Int. Cl. H04L 9/40

(52) U.S. Cl. CPC H04L 63/1433; H04L 63/105

(57) ABSTRACT

Techniques are described for a computing system to maintain security by (a) detecting updates from a plurality of interrelated systems; (b) with reference to the detected updates and a set of mappings, determining an at-risk account having an improper access level; and (c) in response to determining the at-risk account, providing an alert of the at-risk account to an entity authorized to alter or remove the at-risk account. A system, apparatus, and computer program product for performing this method and similar methods are also described.

### CROSS REFERENCE TO RELATED APPLICATION

This application claims priority under 35 USC § 119(e) to U.S. Provisional Patent Application Ser. No. 63/382,831, titled “AUTOMATED SYSTEM ACCESS REVIEW USING INTER-SYSTEM MAPPINGS,” filed Nov. 8, 2022, which is hereby incorporated herein in its entirety by this reference.

### BACKGROUND

Organizations often have a large Information Technology (IT) infrastructure including many different hardware and software systems. Many different individuals are granted access to some or many of these systems via user accounts, depending on the nature of their jobs or other relationships with the organization. IT system administrators typically perform a system access review on an occasional basis to review systems and associated accounts within an organization to ensure that all accounts are associated with known persons who are authorized to access systems at appropriate levels.

### SUMMARY

However, performing such occasional system access reviews by IT system administrators may be difficult, inefficient, incomplete, and untimely. For example, large organizations may include large numbers of disparate systems, and information about who has what access may not always be easy to locate, especially if only some systems are updated with correct information in a timely manner. In addition, even if an IT administrator performs a system access review regularly once per quarter, there may be several months during which improper access may be available. In addition, even if an IT administrator follows all rules and procedures correctly and completely, it may happen that certain users or groups of users have access to systems that are not necessary for their job or tasks.

Thus, it would be desirable to implement a tool that allows data from diverse interrelated systems to be correlated and mapped in order to automatically notify an administrator that a particular account may be in need of review. This may be accomplished by maintaining mappings between events generated by a plurality of interrelated systems and particular accounts that are considered to be at-risk due to those changes. A system collects event data from the plurality of systems, correlates that data with the mappings, and generates warnings about at-risk accounts. In some embodiments, a particular risk level may be assessed for any at-risk account, and the warning may be tailored to that particular risk level.

In one embodiment, a method is described for a computing system to maintain security by (a) detecting updates from a plurality of interrelated systems; (b) with reference to the detected updates and a set of mappings, determining an at-risk account having an improper access level; and (c) in response to determining the at-risk account, providing an alert of the at-risk account to an entity authorized to alter or remove the at-risk account. A system, apparatus, and computer program product for performing this method and similar methods are also described.

### BRIEF DESCRIPTION OF THE DRAWINGS

The foregoing and other objects, features, and advantages will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of various embodiments.

FIG. 1 illustrates an example system, apparatus, computer program product, and associated data structures for use in connection with one or more embodiments.

FIG. 2 illustrates an example method in accordance with one or more embodiments.

### DETAILED DESCRIPTION

A tool is provided that allows data from diverse interrelated systems to be correlated and mapped in order to automatically notify an administrator that a particular account may be in need of review. This may be accomplished by maintaining mappings between events generated by a plurality of interrelated systems and particular accounts that are considered to be at-risk due to those changes. A system collects event data from the plurality of systems, correlates that data with the mappings, and generates warnings about at-risk accounts. In some embodiments, a particular risk level may be assessed for any at-risk account, and the warning may be tailored to that particular risk level.

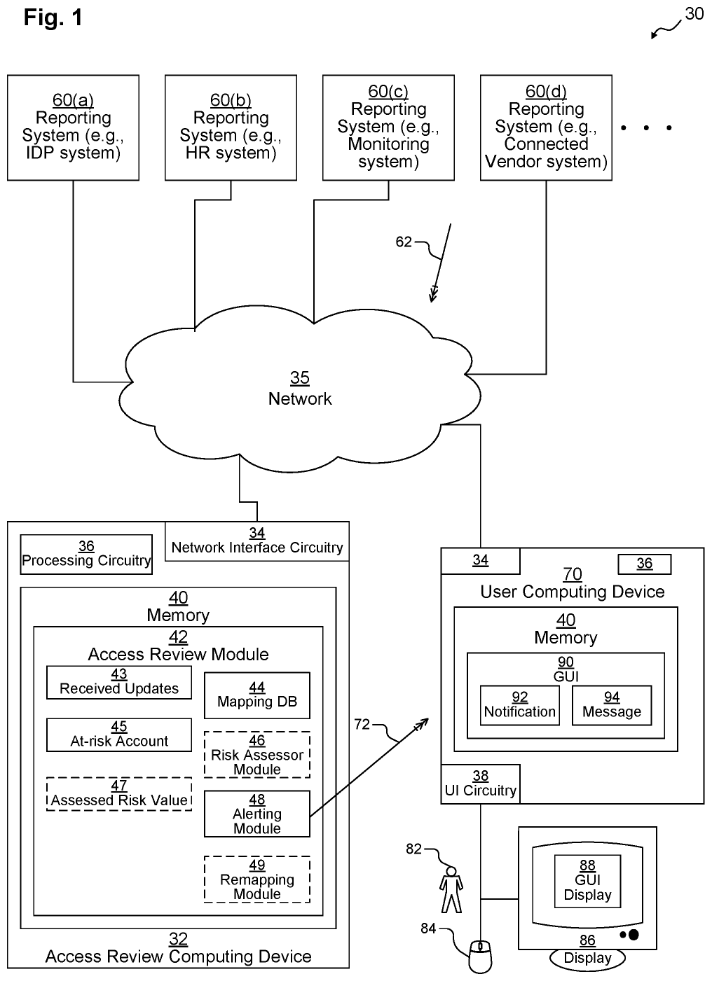

FIG. 1 depicts an example environment 30 for use in connection with various embodiments. Environment 30 includes a network 35, an access review computing device (ARCD) 32, a user computing device 70 operated by a user 82, and a set of reporting systems 60. Network 35 may be any kind of communications network or set of communications networks, such as, for example, a LAN, WAN, SAN, the Internet, a wireless communication network, a virtual network, a fabric of interconnected switches, etc.

Reporting systems 60 are computing systems that provide services to an organization and report on certain changes and updates. For example, in one embodiment, as depicted, reporting system 60(a) is an Identity Provider (IdP) system that manages identities and accounts used to access various systems and resources (not depicted) within the environment 30 of the organization. IdP system 60(a) may detect various updates, such as depicted in Table 1, for example.

TABLE 1
IdP System updates

| Update Identifier | Update |
|---|---|
| 1.0 | Detect IdP |
| 1.1 | Detect new users |
| 1.2 | Detect removed users |
| 1.3 | Detect new application |
| 1.4 | Detect removed application |
| 1.5 | Detect new group membership |
| 1.6 | Detect removed group membership |

As another example, in one embodiment, as depicted, reporting system 60(b) is a Human Resources (HR) Information System (HRIS) that manages core HR needs of an organization, including automatically synchronizing data related to HR. HRIS 60(b) may detect various updates, such as depicted in Table 2, for example.

TABLE 2
HRIS updates

| Update Identifier | Update |
|---|---|
| 2.0 | Detect HRIS user |
| 2.1 | Detect user title changes |
| 2.2 | Detect user department changes |
| 2.3 | Detect user level changes |
| 2.4 | Detect user start date |
| 2.5 | Detect user end date |
| 2.6 | Detect user manager changes |
| 2.7 | Detect user location changes |

As another example, in one embodiment, as depicted, reporting system 60(c) is a Monitoring System that monitors usage of various systems of the organization in the environment 30. Monitoring system 60(c) may detect various updates, such as depicted in Table 3, for example.

TABLE 3
Monitoring System updates

| Update Identifier | Update |
|---|---|
| 3.0 | Detect metadata for flagged accounts |
| 3.1 | Detect user created data |
| 3.2 | Detect user last login |
| 3.3 | Detect user security task assignment |
| 3.4 | Detect user task completion |
| 3.5 | Detect user applications |
| 3.6 | Detect user group |
| 3.7 | Detect user title |
| 3.8 | Detect user department |
| 3.9 | Detect user level |
| 3.10 | Detect user employment date |
| 3.11 | Detect user manager |
| 3.12 | Detect user location |
| 3.13 | Detect system |
| 3.14 | Detect system type |
| 3.15 | Detect system risk level |

As another example, in one embodiment, as depicted, reporting system 60(d) is a Connected Vendor System that manages connections to one or more outside vendors systems. Connected Vendor system 60(d) may detect various updates from external vendor systems, such as depicted in Table 4, for example.

TABLE 4
Connected Vendor System updates

| Update Identifier | Update |
|---|---|
| 4.0 | Detect account data |
| 4.1 | Detect new account |
| 4.2 | Detect user role |
| 4.3 | Detect user permissions |
| 4.4 | Detect user resources |
| 4.5 | Detect user last login |
| 4.6 | Detect vendor changes |
| 4.7 | Detect new vendor |
| 4.8 | Detect removed vendor |

Reporting systems 60 are each configured to send detected updates 62 (e.g., updates detected in Tables 1-4) across network 35 to ARCD 32.

Both ARCD 32 and user computing device 70 may be any kind of computing device, such as, for example, a personal computer, laptop, workstation, server, enterprise server, tablet, smartphone, etc. Both ARCD 32 and user computing device 70 include processing circuitry 36, network interface circuitry 34, and memory 40. In addition, user computing device 70 also includes user interface (UI) circuitry 38 for connecting to a UI input device 84 and a display device 86. ARCD 32 and user computing device 70 may also include various additional features as is well-known in the art, such as, for example, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 34 may include one or more Ethernet cards, cellular modems, Fibre Channel (FC) adapters, InfiniB and adapters, wireless networking adapters (e.g., Wi-Fi), and/or other devices for connecting to a network 35.

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

UI circuitry 38 may include any circuitry needed to communicate with and connect to one or more user input devices 84 and display screens 86. UI circuitry 38 may include, for example, a keyboard controller, a mouse controller, a touch controller, a serial bus port and controller, a universal serial bus (USB) port and controller, a wireless controller and antenna (e.g., Bluetooth), a graphics adapter and port, etc.

Display screen 86 may be any kind of display, including, for example, a CRT screen, LCD screen, LED screen, etc. Input device 84 may include a keyboard, keypad, mouse, trackpad, trackball, pointing stick, joystick, touchscreen (e.g., embedded within display screen 86), microphone/voice controller, etc. In some embodiments, instead of being external to user computing device 70, the input device 84 and/or display screen 86 may be embedded within the user computing device 70 (e.g., a cell phone or tablet with an embedded touchscreen).

Memory 40 of user computing device 70 stores a graphical user interface (GUI) 90 which is configured to execute on processing circuitry 36 of user computing device 70 to interface with a user 82 (e.g., a system administrator) operating UI devices 84, 86 by displaying a GUI display 88 on display 86. In some embodiments, GUI 90 may include a web browser configured to interact with a remote web server.

Memory 40 of ARCD 32 stores an access review module 42 which is configured to execute on processing circuitry 36 of ARCD 32. Access review module 42 is configured to receive updates 62 from reporting systems 60 and store them as received updates 43. Access review module 42 is also configured to maintain a mapping database (DB) 44 and to use the mapping DB 44 to identify one or more at-risk accounts 45. For example, mapping DB 44 includes mappings between different types of updates 62 that indicate that a particular account may be unauthorized, over-authorized, under-authorized, or otherwise at risk. The mappings may also map relationships between accounts or between users and accounts. In some embodiments, these mappings may initially be created by a system administrator such as user 82. In some embodiments, access review module 32 may operate to automatically create some or all the mappings of mapping DB 44. For example, when a new vendor account is created (possibly in the process of a new vendor system being added), access review module 32 may establish mappings between employees identified by HRIS 60(b) and the new vendor account provided by connected vendor system 60(d), and access review module 32 may also establish mappings between user accounts maintained by IdP system 60(a) and the new vendor account provided by connected vendor system 60(d). In some embodiments, access review module 32 may establish these mappings by looking for matching patterns, such as, for example, matching user names or identifiers shared between accounts or by looking at identifying e-mail addresses.

As an example, an update 62 identified by update identifier 2.5 (see Table 2) may indicate that an employee has been terminated and should therefore be removed as a user for all locally-managed accounts (see update identifier 1.2 from Table 1), or vice-versa. As another example, an update 62 identified by update identifier 2.4 (see Table 2) may indicate that a new employee has been hired and should therefore be added as a user for all locally-managed accounts (see update identifier 1.1 from Table 1), or vice-versa. Update identifier 3.10 (see Table 3) may also be implicated in these situations. Mapping DB 44 may be referenced both to map from one update type to another (e.g., 2.5 to 1.2) as well as to map from one user or account to another account (e.g., mapping that employee X identified by HRIS 60(b) is linked to accounts Y and Z maintained by IdP system 60(a)).

As another example, an update 62 identified by update identifier 2.1, 2.2, or 2.3 (see Table 2) may indicate that an employee has changed positions and therefore access to various applications should be added or removed (see update identifier 1.3 or 1.4 from Table 1) and/or that employee's user accounts should be added or removed from certain groups (see update identifier 1.5 or 1.6 from Table 1), or vice-versa. Update identifiers 3.3, 3.4, 3.5, 3.6, 3.7, 3.8,and 3.9 (see Table 3) may also be implicated in these situations. Again, mapping DB 44 may be referenced both to map from one update type to another (e.g., 2.1-2.3 to 1.3-1.6) as well as to map from one user or account to another account (e.g., mapping that employee X identified by HRIS 60(b) is linked to accounts Y and Z maintained by IdP system 60(a)).

As another example, updates 62 identified by update identifiers 3.1, 3.2, and 3.5 (see Table 3) may indicate that a user has or has not used a particular application recently (e.g., within the past 6 months or 1 year) and therefore it might be appropriate to remove access to that application for that user (see update identifier 1.4 from Table 1).

As another example, an update 62 identified by update identifier 2.5 (see Table 2) may also indicate that an employee has been terminated and should therefore be removed as a user for all vendor accounts (which are known to exist due to previously receiving updates identified by update identifier 4.1). Similarly, an update 62 identified by update identifier 2.4 (see Table 2) may also indicate that a new employee has been hired and should therefore be added as a user for all relevant vendor accounts (see update identifier 4.1 from Table 4). Mapping DB 44 may be referenced both to map from one update type to another (e.g., 2.4 to 4.1) as well as to map from one user or account to another account (e.g., mapping that employee X identified by HRIS 60(b) is linked to external accounts P and Q that are managed by connected vendor system 60(d)).

Access review module 42 also includes an alerting module 48 that is configured to send an alert 72 to one or more user computing devices 70 indicating an at-risk account. This alert 72 may be displayed to a user 82 of the receiving user computing device 70 as a notification 92 or a message 94, depending on the embodiment or the use case. In some embodiments, alerts 72 about different at-risk accounts may be aggregated together and sent to the user 82 at periodic intervals (e.g., once per day).

In some embodiments, access review module 42 also includes a risk assessor module 46 that is configured to assess a risk value 47 associated with an at-risk account 45. For example, in one embodiment, risk assessor module 46 assesses a risk value 47 of level 4 for at-risk accounts 45 that were deemed at-risk due to a received update 43 of a type indicated in Table 1; a risk value 47 of level 3 for at-risk accounts 45 that were deemed at-risk due to a received update 43 of a type indicated in Table 2; a risk value 47 of level 2 for at-risk accounts 45 that were deemed at-risk due to a received update 43 of a type indicated in Table 4; and a risk value 47 of level 1 for at-risk accounts 45 that were deemed at-risk due to a received update 43 of a type indicated in Table 3.

Alerting module 48 may be configured to change the type of alert 72 that it issues for any given at-risk account 45 based on its associated assessed risk value 47. For example, in one embodiment, for an at-risk account 45 having an associated assessed risk value 47 of level 4, alerting module sends alert 72 as a GUI notification 92 that is configured to appear in a portion of the GUI 90 dedicated to upcoming access reviews (e.g., only visible within GUI display 88 when the user 82 opts to view a page describing upcoming access reviews); for an at-risk account 45 having an associated assessed risk value 47 of level 3, alerting module sends alert 72 as a GUI notification 92 that is configured to appear in a more prominent portion of the GUI 90 (e.g., a homepage); for an at-risk account 45 having an associated assessed risk value 47 of level 2, alerting module sends alert 72 as a GUI message 94 that is directed towards a particular user 82 who is assigned to perform access reviews for that type of account; and for an at-risk account 45 having an associated assessed risk value 47 of level 1, alerting module sends alert 72 as a GUI message 94 that is directed towards all administrators of environment 30 to ensure that it is seen quickly. In some embodiments, alerts 72 about at-risk accounts with less urgent risk values 47 (e.g., risk values 47 of levels 3 and 4) may be aggregated together and sent to the user 82 at periodic intervals (e.g., once per day), while alerts 72 about at-risk accounts with more urgent risk values 47 (e.g., risk values 47 of levels 1 and 2) may be sent in real-time.

It should be understood that the creation of one alert 72 may also trigger creation of a second alert 72. For example, if an employee has been terminated (see update identifier 2.5 from Table 2) triggering an alert 72 that that employee should therefore be removed as a user for all locally-managed accounts (see update identifier 1.2 from Table 1), then another alert 72 may also be generated to indicate that any vendor accounts mapped to that employee's locally-managed accounts should also be removed by the connected vendor system 60(d). As another example, if a user has or has not used a particular application recently (see update identifiers 3.1, 3.2, and 3.5 from Table 3) triggering an alert 72 that it might be appropriate to remove access to that application for that user (see update identifier 1.4 from Table 1)), then another alert 72 may also be generated to indicate that any vendor accounts mapped to that employee's locally-managed accounts should also have access to similar applications removed by the connected vendor system 60(d).

In some embodiments, access review module 42 also includes a remapping module 49 that is configured to detect an action performed by a user 82 in response to the alert 72 and to update mapping DB 44 accordingly. For example, if at-risk accounts 45 which were identified in response to received updates 43 of a particular type are routinely left alone with no action taken in response, remapping module 49 may update mapping DB 44 to remove or modify mappings indicating that received updates 43 of that particular type are indicative of an at-risk account 45 of that type. As another example, if an employee X is initially mapped to user account Z, but after an alert 72 is sent to user 82 recommending that some action be take on account Z (in response to an update regarding employee X), user 82 does not take the recommended action (e.g., changing account permissions) for account Z but instead takes the recommended action for account T, then remapping module 49 may take note and update mapping DB 44 to remove the mapping of employee X to user account Z, replacing it with a mapping of employee X to user account T.

Memory 40 may also store various other data structures used by the OS, modules 42, 46, 48, GUI 90, and various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32, 70 is powered off. The OS, modules 42, 46, 48, GUI 90, and various other applications and drivers are typically stored in this persistent storage portion of memory 50 so that they may be loaded into a system portion of memory 40 upon a system restart or as needed. The OS, modules 42, 46, 48, GUI 90, and various other applications and drivers, when stored in non-transitory form either in the volatile or persistent portion of memory 40, each form a computer program product. The processing circuitry 36 running one or more applications thus forms a specialized circuit constructed and arranged to carry out the various processes described herein.

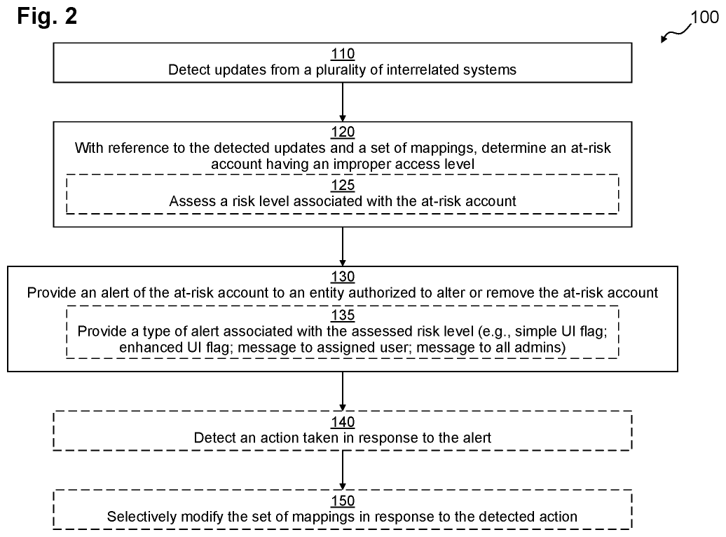

FIG. 2 illustrates an example method 100 performed by a computing device (e.g., ARCD 42) for providing security-related information. It should be understood that any time a piece of software (e.g., OS, modules 42, 46, 48, GUI 90, etc.) is described as performing a method, process, step, or function, what is meant is that a computing device (e.g., ARCD 32 or user computing device 70) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order. Dashed lines indicate that a step or sub-step is either optional or representative of alternate embodiments or use cases.

In step 110, access review manager 42 detects updates 62 from a plurality of interrelated systems 60 (e.g., receiving and storing the updates 62 as received updates 43).

In step 120, access review manager 42, with reference to the received updates 43 and a set of mappings (e.g., stored within mapping DB 44), determines an at-risk account 45 having an improper access level. In some embodiments, step 120 may include sub-step 125 in which risk assessor module 46 assesses an assessed risk value 47 associated with the at-risk account 45.

In step 130, alerting module 48 provides an alert 72 (e.g., a notification 92 or message 94) of the determined at-risk account 45 to an entity (e.g., user 82) who is authorized to alter, add, or remove the at-risk account 45. In some embodiments, step 130 includes sub-step 135 in which alerting module takes the assessed risk value 47 associated with the at-risk account 45 into consideration when determining what type of alert 72 to send. For example, the alert may be a notification 92 that is a simple GUI flag (e.g., visible only on a particular page of GUI 90) or an enhanced GUI flag (e.g., visible on a homepage or all pages of the GUI 90) or a message 94 that is sent only to an assigned user 82 or to all (or many) administrators of the environment 30. In some embodiments, as part of step 130, alert 72 may be sent to one of the reporting systems 60 with the alert 72 serving to direct that reporting system 60 to automatically make the suggested change.

In some embodiments, in step 140, remapping module 49 detects an action taken in response to the alert 72 (e.g., by the user 82). Then, in step 150, remapping module 49 selectively modifies the mapping DB 44 in response to the action detected in step 140, such as by removing, adding, or modifying a mapping of the mapping DB. In some embodiments, step 150 may be performed using machine learning, such as by inputting the responsive action as well as one or more of the received updates 43, the determined at-risk account 45, and the assessed risk value 47 into a neural network.

Thus, a tool has been provided that allows data from diverse interrelated systems 60 to be correlated and mapped in order to automatically notify an administrator 82 that a particular account 45 may be in need of review. This may be accomplished by maintaining mappings (e.g., within mapping DB 44) between events 43 generated by a plurality of interrelated systems 60 and particular accounts that are considered to be at-risk due to those changes. A system collects event data 43 from the plurality of systems 60, correlates that data with the mappings DB 44, and generates warnings 72 about at-risk accounts 45. In some embodiments, a particular risk level 47 may be assessed for any at-risk account 45, and the warning 72 may be tailored to that particular risk level 47.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that although access review module 42 has been described as being stored within memory 40 of and executing on processing circuitry 36 of ARCD 32, that is by way of example only. In other embodiments, the functionality of access review module 42 and its various components may instead be distributed across a plurality of computing devices similar to ARCD 32.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicant makes no admission that such technique, method, apparatus, or other concept is actually prior art under 35 U.S.C. § 102 or 103, such determination being a legal determination that depends upon many factors, not all of which are known to Applicant at this time.

What is claimed is:

1. A method, performed by a computing system, of maintaining security, the method comprising:
detecting updates from a plurality of interrelated systems;
with reference to the detected updates and a set of mappings, determining an at-risk account having an improper access level; and
in response to determining the at-risk account, providing an alert of the at-risk account to an entity authorized to alter or remove the at-risk account.

2. The method of claim 1 wherein the method further includes:
detecting an action taken by the entity in response to the notification; and
in response to detecting the action, selectively modifying the set of mappings.

3. The method of claim 2 wherein selectively modifying the set of mappings includes one of removing, adding, and modifying a mapping of the set of mappings.

4. The method of claim 2 wherein selectively modifying the set of mappings includes performing machine learning.

5. The method of claim 1 wherein determining the at-risk account having the improper access level includes assessing a risk level associated with the at-risk account.

6. The method of claim 5 wherein providing the alert of the at-risk account to the entity includes basing a type of the alert on the assessed risk level.

7. The method of claim 6 wherein basing the type of the alert on the assessed risk level includes:
for a first at-risk account having a lowest assessed risk level, setting the alert to be a notification configured to display within a graphical user interface (GUI) of the entity authorized to alter or remove the at-risk account only when the entity chooses to view notifications; and
for a second at-risk account having a highest assessed risk level, setting the alert to be a message configured to immediately display within the GUI of all administrators of the computing system.

8. The method of claim 7 wherein basing the type of the alert on the assessed risk level further includes for a third at-risk account having an intermediate assessed risk level, setting the alert to be a notification or message configured to immediately display within the GUI of the entity authorized to alter or remove the at-risk account.

9. The method of claim 1 wherein the plurality of interrelated systems includes:
an Identity Provider system that manages identities and accounts used to access various systems and resources; and
a Monitoring System that monitors usage of various systems.

10. The method of claim 1 wherein the method further comprises establishing the set of mappings by looking for matching patterns.

11. A computer program product comprising a non-transitory computer-readable storage medium storing instructions, which, when executed by processing circuitry of a computing system, cause the computing system to maintain security by:
detecting updates from a plurality of interrelated systems;
with reference to the detected updates and a set of mappings, determining an at-risk account having an improper access level; and
in response to determining the at-risk account, providing an alert of the at-risk account to an entity authorized to alter or remove the at-risk account.

12. The computer program product of claim 11 wherein the instructions, when executed by the processing circuitry, further cause the processing circuitry to:
detect an action taken by the entity in response to the notification; and
in response to detecting the action, selectively modify the set of mappings.

13. The computer program product of claim 11 wherein determining the at-risk account having the improper access level includes assessing a risk level associated with the at-risk account.

14. The computer program product of claim 13 wherein providing the alert of the at-risk account to the entity includes basing a type of the alert on the assessed risk level.

15. The computer program product of claim 14 wherein basing the type of the alert on the assessed risk level includes:
for a first at-risk account having a lowest assessed risk level, setting the alert to be a notification configured to display within a graphical user interface (GUI) of the entity authorized to alter or remove the at-risk account only when the entity chooses to view notifications; and
for a second at-risk account having a highest assessed risk level, setting the alert to be a message configured to immediately display within the GUI of all administrators of the computing system.

16. A computing system comprising:
network interface circuitry configured to connect to a plurality of interrelated systems; and
processing circuitry coupled to memory configured to cause the computing system to maintain security by:
detecting updates from the plurality of interrelated systems;
with reference to the detected updates and a set of mappings, determining an at-risk account having an improper access level; and
in response to determining the at-risk account, providing an alert of the at-risk account to an entity authorized to alter or remove the at-risk account.

17. The computing system of claim 16 wherein the processing circuitry coupled to memory is further configured to:
detect an action taken by the entity in response to the notification; and
in response to detecting the action, selectively modify the set of mappings.

18. The computing system of claim 16 wherein determining the at-risk account having the improper access level includes assessing a risk level associated with the at-risk account.

19. The computing system of claim 18 wherein providing the alert of the at-risk account to the entity includes basing a type of the alert on the assessed risk level.

20. The computing system of claim 19 wherein basing the type of the alert on the assessed risk level includes:
for a first at-risk account having a lowest assessed risk level, setting the alert to be a notification configured to display within a graphical user interface (GUI) of the entity authorized to alter or remove the at-risk account only when the entity chooses to view notifications; and
for a second at-risk account having a highest assessed risk level, setting the alert to be a message configured to immediately display within the GUI of all administrators of the computing system.
